(19) United States
(12) Patent Application Publication
(10) Pub. No.: US 2022/0183256 A1
(43) Pub. Date: Jun. 16, 2022

(54) Harnessing Animal Precognition in a Structural Design with Feedback

(71) Applicants: Martin Rosenblatt, Woodland Hills, CA (US); Donna Tanner, Wellington, NV (US)

(72) Inventors: Martin Rosenblatt, Woodland Hills, CA (US); Donna Tanner, Wellington, NV (US)

(21) Appl. No.: 17/531,694

(22) Filed: Nov. 19, 2021

Related U.S. Application Data
(60) Provisional application No. 63/116,256, filed on Nov. 20, 2020.

(51) Int. Cl. A01K 15/02

(52) U.S. Cl. CPC A01K 15/02

(57) ABSTRACT

Harnessing Animal Precognition in a Structural Design with FeedBack is disclosed. The invention is designed so the animals must choose from multiple possible channels when the precognitive prediction cycle begins. Their choices must be made before any information is known to anyone, in the normal sense, about the future outcome. Each channel is associated with a POSSIBLE prediction outcome. Access to the channels will be blocked after the animals make their choices. Those that choose the correct channel, i.e., based on the ACTUAL outcome, will be fed the baseline meal PLUS treats after the outcome is known—this is positive FeedBack. Those that choose incorrectly, will only be fed their baseline meal.—this is negative FeedBack. Yummy treats will enhance their precognitive ability for the next and subsequent predictions.

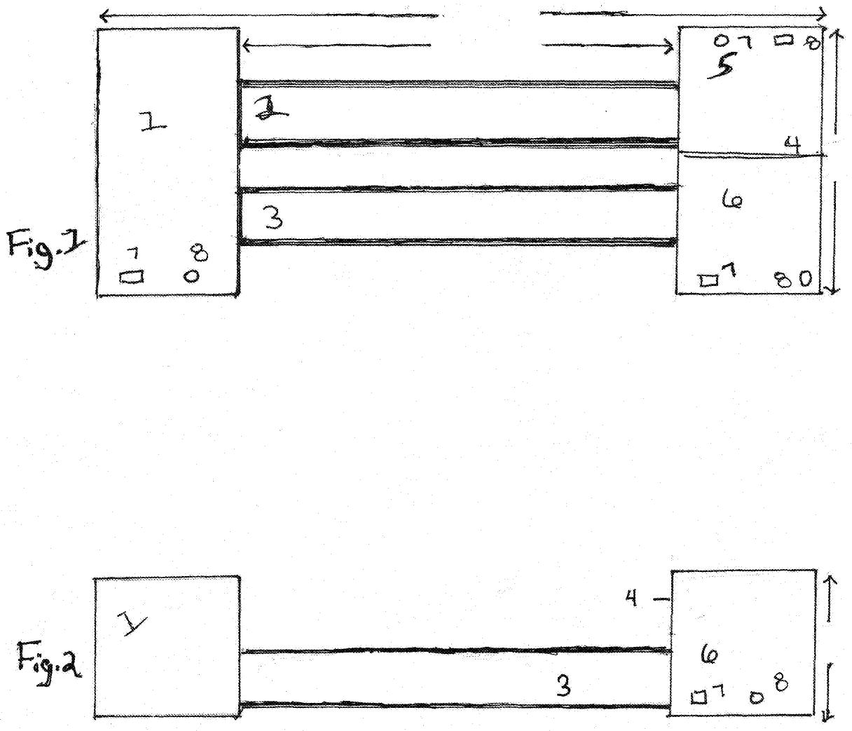

This system encourages and enhances precognition in animals and provides an opportunity for real-world applications for predicting future outcomes.

### BACKGROUND OF THE INVENTION

Problem Solved: Predicting the one actual future outcome from multiple possible future outcomes . . . this is a type of precognition.

In other precognitive systems with animals, there was neither positive nor negative FeedBack. It is important to note that in our design, a baseline food meal plus yummy treats are the positive motivating FeedBack. The baseline meal, without treats, is the negative FeedBack. It is well known that animals will work for pleasurable things, and yummy treats are a motivating factor for activating the natural precognitive abilities in the animals.

An example of the use of this invention would be a “tasking” to predict the winner of a football game between Team A and Team B. The Tasking, of course is done, before the game begins.

In humans, the predictors are cued before the game starts with “Describe and/or Sketch Your FeedBack Photo”. In humans, there are two photos chosen before the game starts; one photo is randomly associated with Team A and the other with Team B. An analyst looks for the best match between photos A and B thereby making a prediction on the winning team. After the game, only the correct photo is shown to the predictor as FeedBack. This approach is called Associative Remote Viewing: http://www.p-i-a.edu/Protocols/EDU/ARV_Background.htm

In animals, a dividing gate is opened before the game begins which permits access to two possible channels (and FeedBack chambers, see sketch) for the animals to go down. Each of these channels lead to where the now-empty feeders are. One channel is labelled and associated with Team A, the other channel is labelled and associated with Team B. The gate is closed before the game begins. A pleasant sound is used to alert the animals of (1) when the gate is opening and (2) when the actual outcome is known and appropriate food will be put in the feeder for Channel A or B.

With either one or multiple animals, the operator/analyst can predict Team A versus Team B, by the channel/chamber having the most animals in it. After the winner of game is known, the appropriate FeedBack of food is placed in the feeders Again, for those animals that predicted correctly, Team A or Team B as the winner, they get yummy treats. The baseline meal is provided for any animals in the channel/chamber associated with the losing team. This baseline meal is enough to live on without treats.

We will always provide FeedBack to all the animals. We do not want any animal to die. The invention is designed so the animals must choose from multiple possible channels when the prediction begins. The channels will be closed after they make their choices.

In humans, it has been shown that FeedBack increases precognitive success rates: “Predicting the Stock Market: An Associative Remote Viewing Study”) is by Maximilian Muller and Laura Muller at the IGPP (Institute for Frontier Areas of Psychology and Mental Health) in Freiburg, Germany. Here is the link https://pdfhost.io/v/v.syNRbu_MullerWittmannARV_ZfA_20193pdf

### DETAILED DESCRIPTION OF THE INVENTION

Predicting the one actual future outcome from multiple possible future outcomes, using animals and a special enclosure, is the invention . . . this is a type of precognition. The invention claimed here solves this problem with animals and an innovative design concept permitting a precognitive choice for getting yummy food if the predictive choice is correct.

Data will ultimately evaluate our strong belief that animal precognition success rates will be significantly higher compared to humans.

### The Claimed Invention Differs from What Currently Exists

In our prototype, we are working with animals . . . starting with laboratory rats. We have both positive and negative FeedBack designed in our invention. Other work has been done with “Animals in Psi Research”, e.g. https://psi-encyclopedia.spr.ac.uk/articles/animals-psi-research. The closest precognition example is here: https://en.wikipedia.org/wiki/Paul_the_Octopus The octopus was always fed . . . so no meaningful feedback went to the animal.

Our precognitive invention is different and better because we have a special structural design which will enhance the animal precognition using FeedBack, positive and baseline. Structures can be easily constructed for multiple (two or more) possible outcomes. The positive FeedBack is yummy treats for the animals that are correct in their precognitive prediction. Over time, the animals will learn that only their precognitive abilities will provide reliable and extra-yummy food.

### This Invention is an Improvement on What Currently Exists

FeedBack, positive or baseline, is provided for the animals to learn to fully activate their instinctual precognitive abilities. In nature, survival, motivates animals to use their precognitive capabilities. For example, animals avoiding tsunamis: https://www.seeker.com/tsunamis-and-animal-sixth-sense-warnings-1765194026.html

We will always provide FeedBack to those animals that choose the correct outcome. The invention is designed so the animals must choose from multiple possible channels when the prediction begins. The channels will be closed after they make their choices. Those that choose incorrectly, will not be fed on a baseline meal. Hunger is a motivating factor which will enhance their precognitive ability for the next and subsequent predictions. However, we will not let any animals starve . . . just be hungry.

### THE TWO CHOICE VERSION OF THE INVENTION DISCUSSED HERE INCLUDES (SEE SKETCH)

1. Main compartment
2. Channel A
3. Channel B
4. Divider/Gate between Main compartment and 2 channels in this simple binary example.
5. Prediction/Feed Back Chamber A
6. Prediction/Feed Back Chamber B
7. Gravity Feeder A
8. Gravity Feeder B

### Relationship Between the Components:

(1) is main compartment which is adjacent to the two possible channels for food (2 and 3). There is a divider or gate (4) which remains closed until a prediction cycle begins. (4) is the divider/gate which opens when a prediction cycle starts, and then stays down after the animals have chosen their channel A (5) or B (6) which lead to the feedback chambers A or B (7 or 8). Only the correct Outcome feeder (7 Associated with outcome A) or (8 Associated with outcome B) will be loaded with the yummy inspirational food after the correct Outcome, A or B, is known. The other feeder will have the baseline meal.

The feeders are associated with the two possible outcomes (Outcome A and Outcome B) before the prediction cycle starts. The animal's precognitive ability is used to choose Channel A (2) or Channel B (3) when the Divider/Gage (4) is lifted.

This is an example with two possible outcomes. Simple modifications of this design can accommodate multiple possible outcomes.

### How the Invention Works:

In this example, we are using two possible OUTCOMES (OUTCOME A and OUTCOME B) for the prediction of the actual future outcome (either A or B). The idea easily works for future predictions with multiple outcomes. This approach works with one animal (say lab rat) or multiple animals in the structure. In this example, we assume multiple animals in the structure.

The structural aspect of our invention is called the “precog enclosure” or simply the enclosure. The initial prototype enclose is designed so that smallish animals, like mice and lab rats, must use their natural precognitive capabilities to choose which channel to go down for food. This choice must be made before any information is known to anyone, in the normal sense, about the future outcome. A sumptuous meal is the motivation for the animal to choose the correct opening.

The enclosure harnesses precognition with these major compartments: main living quarters (1), two Channels (2) and (3) with a dividing element or gate (4)—see sketch. Each Channel is connected to an isolated FeedBack chamber (5) and (6). The food is provided in the FeedBack chamber via Feeders (7) or (8)). Before a prediction cycle starts, the dividing element or gate is down confining the animals in their living quarters . . . no food is available there.

Step 1 of a prediction cycle is the raising of the dividing element or gate (4) to permit the animals to make their choices of which channel to go down for food. The operator has already marked each channel with OUTCOME A versus OUTCOME B.

Step 2 is lowering the dividing element (4) again so there is no access to the living quarters or the other channel. The animals have made their precognitive choices.

Step 3 and Step 4 is waiting until the actual outcome is known, i.e., either OUTCOME A or OUTCOME B. The animals are in their choice of Channel A or B with Chamber A or B.

Step 5 and 6 is to put food in the gravity feeder for the actual outcome A or B; either Feeder A (7) or Feeder B (8). Those animals who correctly chose the actual outcome are now getting yummy treats added to their baseline food. This FeedBack is encouragement for future predictions. Those that chose the wrong outcome only their baseline food.

Step 7, after the animals finish eating, the dividing element/gate is raised to let the animals return to their living quarters. When all animals are in their living quarters, and some ushering may be necessary, the dividing element/gate will be lowered. We are now ready for the next prediction.

### How to Make the Invention:

Wire and wire mesh, which are strong enough to secure the animals, will work for all compartments and the dividing element.

Other materials could be used, but cleaning works best with wire mesh at the bottom and collection trays under that. In the prototype we used wire bars in some components.

All compartments, the dividing elements, and the two gravity feeders are necessary. Adding playful items and private rest areas will be helpful for keeping the animals happy.

This idea is easily adapted to multiple possible outcomes by simply adding more channels with FeedBack chambers.

Using a circular living quarter with radial channels and chambers is an obvious extension and we claim our invention includes this type of modification. Also, multiple elevations can be easily designed as choices for the animals.

### How to Use the Invention:

Step 1 of a prediction cycle is the raising of the dividing element or gate (4) to permit the animals to make their choices of which channel to go down for food. The operator has already marked each channel and associated chamber with OUTCOME A versus OUTCOME B.

Step 2 is lowering the dividing element (4) again so there is no access to the living quarters or the other channel. The animals has made their precognitive choice.

Step 3 and Step 4 is waiting until the actual outcome is known, i.e., either OUTCOME A or OUTCOME B. The animals are in their choice of Channel A or B with Chamber A or B.

Step 5 and 6 is to put food in the gravity feeder for the actual outcome A or B; either Feeder A (7) or Feeder B (8). Those animals who correctly chose the actual outcome are now getting food as their FeedBack encouragement for future predictions. Those that chose the wrong outcome get no food (this is negative FeedBack). A bit of hunger will motivate them to use their precognitive abilities for future predictions.

Step 7, after the animals getting food finish eating, is raising the dividing element/gate to let the animals return to their living quarters. When all animals are in their living quarters, and some ushering may be necessary, the dividing element/gate will be lowered. We are now ready for the next prediction. The timing between predictions is a variable set by the human operator.

Additionally: This invention can be used for a very broad range of predictions, e.g., the outcome of:

1. Financial Markets, especially Short-term Commodity Futures Markets. Profitable Up or Down price movement outcomes can occur within a day which is fine for the animal feeding cycle. For example, Outcome A and Outcome B can be Up and Down (not Up).
2. Sporting Events involving team winner, favorite with points, and over/under wagers, etc.

Also, horse racing winner and/or place and/or show using multiple precog/feedback channels can be predicted.

3. Lottery Pics: Multiple channels and feedback chambers can correspond to the multiple possible lottery pick numbers.

Horse racing and lottery picks require using something like a circular home-base with multiple channels. For example, for the standard pick 3, 10 channels would be used to cover all possible numbers from 0 to 9.

Additionally, this invention can create: Those animals that do the best, can be bred to raise even better precognitive animals.

1. Our claim concerns using animals for predicting the actual outcome from 2 or more possible outcomes in the future. Predicting the one actual future outcome involves a special uniquely designed enclosure that captures, or harnesses, precognition in animals, by providing decision making prediction chambers. In this way the animals can use their precognitive abilities to choose the chamber where they will receive the “yummy” treat in the future. The design of the enclosure also provides the functionality, that can be used to make choices about future events. The enclosure design not only provides excellent environmental stimulus for the animals, but it can also be put together in different configurations in order to make binary predictions or predictions that involve multiple decisions to predict a single outcome in the future such as a lottery outcome. The design also incorporates uniquely designed tunnel systems that mimic natural environments that keep the animals healthier and improve instinctual and precognitive behaviors. This claim applies animal precognition using an Innovative and unique enclosure design permitting the animals to receive extra “yummy” food if the predictive choice is correct. This invention design gives the animals a way to communicate their precognitive behavior, therefore allowing practical applications when determining future event outcomes.
